(19) United States
(12) Patent Application Publication
(10) Pub. No.: US 2010/0225093 A1
(43) Pub. Date: Sep. 9, 2010

(54) Foldable Golf Cart

(76) Inventor: WEN-TSAN LIN, Taichung (TW)

Correspondence Address: HDLS IPR Services, PO Box 220746, Chantilly, VA, 20153, US

(21) Appl. No.: 12/398,158

(22) Filed: Mar. 4, 2009

(51) Int. Cl. B62B 3/02

(52) U.S. Cl. 280/642

(57) ABSTRACT

A foldable golf cart with a front wheel of detachable and foldable, includes a frame body, the frame body having a first bracket and a second bracket at the bottom thereof, a rotation shaft mechanism, being disposed between the first bracket and the second bracket, and having a rotation shaft, the rotation shaft having an insert connecting portion, the insert connecting portion being disposed a clip thereon; a front wheel, movably and rotatably disposed on a wheel mount, the wheel mount being inserted into the insert connecting portion, and the clip being benefiting for fixing or releasing the wheel mount of the front wheel, by the rotation shaft mechanism, the front wheel could be expanded or folded, while by the clip, the front wheel could be detached or assembled.

### BACKGROUND

1. Field of the Invention

The present invention relates to foldable golf carts, and more particularly, to a golf cart wherein the front wheel is detachable and foldable.

2. Description of the Related Art

Golf sports not only have sports effects, but also have leisure, sociality and entertainment functions, and are enjoyed by people during recent years. For satisfying different situations, different kinds of golf clubs are needed to be prepared by users, and the golf clubs are placed into special golf bags under the convenience for carrying and protection consideration, meanwhile under the consideration of reducing users' burden, push style golf cart is of a nice choice.

If the present golf carts are distinguished by the amount of the wheels, two-wheeled and three-wheeled golf carts are mainly included. Two-wheeled golf carts have the advantages of portable and easily to be stored, besides its stability being inferior to three-wheeled golf carts. Three-wheeled golf carts have the advantages of stable and easily to use, but of a large volume, which affects its transportation, storage space and convenience. Therefore, the design of an easily assembled and detached third wheel (i.e., the front wheel), which can extend from and fold with the frame body of the golf cart, can overcome the forgoing shortcomings.

### BRIEF SUMMARY

The present invention provides a golf cart with a front wheel of easily assembled and detached, and can extend from and fold together with the frame body of the gold cart.

The golf cart of the present invention comprises a frame body, a rotation shaft mechanism, a clip and a front wheel. The frame body has a top end and a bottom end. Lateral sides of the frame body respectively have a first side frame and a second side frame. The first side frame and the second side frame are respectively and axially disposed a first wheel and a second wheel thereon. The first wheel and the second wheel are capable of in-situ rotation, and the bottom of the frame body having a first bracket and a second bracket.

The rotation shaft mechanism includes a rotation shaft. Lateral sides of the rotation shaft respectively have an abutting surface, and the rotation shaft at an axial direction thereof have a through hole. A first shaft fixing part is disposed at a lateral side of the rotation shaft, and has a braking surface corresponding to the abutting surface of the rotation shaft. The first shaft fixing part has a horizontal perforation and a vertical perforation. The first bracket is received in the vertical perforation. A second shaft fixing part is disposed at the other side of the rotation shaft, and has a braking surface corresponding to the abutting surface of the rotation shaft, while the second shaft fixing part has a horizontal perforation and a vertical perforation. The second bracket is received in the vertical perforation. A first resilient member is disposed between the first shaft fixing part and the rotation shaft. A second resilient member is disposed between the second shaft fixing part and the rotation shaft. An operation lever is received in the through hole of the rotation shaft and the horizontal perforations of the first and the second shaft fixing parts at lateral sides of the rotation shaft, and the operation lever has an escape prevention part at an end thereof and an eccentric wrench at other end thereof. When the eccentric wrench of the operation lever compresses the first and the second shaft fixing parts, to urge and fix the rotation shaft, the first and the second resilient members are compressed to store energy. When the eccentric wrench is released, the first and the second resilient members release the energy and distract the rotation shaft mechanism, and the first and the second shaft fixing parts to release the rotation shaft. An insert connecting portion is disposed along an radial direction of the rotation shaft, the insert connecting portion has an insert hole, and the insert connecting portion at a lateral side thereof has a hole communicated with the insert hole.

The clip has a clip tongue, by means of operating the clip, the clip tongue extending through the hole and into the insert hole or detaching from the insert hole.

The front wheel is rotatably and axially disposed on a wheel mount. The wheel mount has an insert part, and the insert part at its at least a lateral side has an indentation. When the insert part is inserted into the insert hole of the insert connecting portion, the clip tongue of the clip is clasped into the indentation of the insert part, so that the wheel mount for the front wheel is fixed. When the clip tongue of the clip is released, the wheel mount for the front wheel is released and detached from the insert connecting portion

According to the present invention, the wheel shaft of the first wheel is pivotally disposed a rotation shaft thereon, the rotation shaft has a fixing portion, and the fixing portion has an indentation along a radial direction thereof. The first side frame has an insert connecting portion, the insert connecting portion has an insert hole corresponding to the fixing portion, and the insert connecting portion at a lateral side thereof has a hole communicated with the insert hole. When the fixing portion is inserted into the insert hole of the insert connecting portion, the clip tongue of the clip is clasped to fix the rotation shaft, and conversely to release the rotation shaft.

According to the present invention, the wheel shaft of the second wheel is pivotally disposed a rotation shaft thereon, the rotation shaft has a fixing portion, and the fixing portion has an indentation along a radial direction thereof. The second side frame has an insert connecting portion, the insert connecting portion has an insert hole corresponding to the fixing portion, and the insert connecting portion at a lateral side thereof having a hole communicated with the insert hole. When the fixing portion is inserted into the insert hole of the insert connecting portion, the clip tongue of the clip is clasped to fix the rotation shaft, and conversely to release the rotation shaft.

According to the present invention, the first wheel has a stop wheel at a lateral side thereof, while the first side frame is pivotally disposed a braking lock thereon, the braking lock at a first position clasps the stop wheel, and at a second position releases the stop wheel. The first side frame is movably and pivotally disposed an insert connecting portion for uniting the first wheel, and the braking lock is disposed on the insert connecting portion.

According to the present invention, the second wheel has a stop wheel at a lateral side thereof, while the second side frame is pivotally disposed a braking lock thereon, the braking lock at a first position clasps the stop wheel, and at a second position releases the stop wheel. The second side frame is movably and pivotally disposed an insert connecting portion for uniting the second wheel, and the braking lock is disposed on the insert connecting portion

According to the present invention, the stop wheel has a plurality of clasping grooves, while the braking lock has a plurality of corresponded clasping bolts.

According to the present invention, the golf cart may further comprise a bag mount mechanism on the rotation shaft mechanism, the bag mount mechanism co-rotating with the rotation shaft mechanism.

According to the present invention, the golf cart may further comprise a bag mount mechanism, the bag mount mechanism integrally forming a bag mount, the bag mount having a rotation shaft seat and an insert connecting portion seat at a bottom end thereof, the rotation shaft seat and the insert connecting portion seat being fixed to the corresponded rotation shaft and insert connecting portion.

According to the present invention, the first bracket has a perforation, while the second bracket has a perforation corresponding to the perforation. When the first bracket is received in the vertical perforation of the first shaft fixing part, and the second bracket is received in the vertical perforation of the second shaft fixing part, the operation lever extends through the two perforations.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an expanded, perspective view of the golf cart according to a preferred embodiment of the present invention.

FIG. 2 is an exploded, perspective view of the first wheel, the second wheel and the braking structure of the golf cart, according to the preferred embodiment of the present invention.

FIG. 3 is a schematic view shown expanding and folding operation of the golf cart, according to the preferred embodiment of the present invention.

FIG. 4 is an assembled, three-dimensional view of the first wheel (or the second wheel) and the braking structure of the golf cart, according to the preferred embodiment of the present invention.

FIG. 5 is a cross section view of FIG. 4.

FIGS. 6 and 6A are operating views when the braking lock of the braking structure of the golf cart, according to the preferred embodiment of the present invention, is at different positions, FIG. 6A is at a first position while FIG. 6 is at a second position.

FIG. 7 is a cross section view of the rotation shaft mechanism of the front wheel of the golf cart, according to the preferred embodiment of the present invention.

FIG. 8 is an exploded view of the rotation shaft mechanism of the front wheel of the golf cart, according to the preferred embodiment of the present invention.

### DETAILED DESCRIPTION

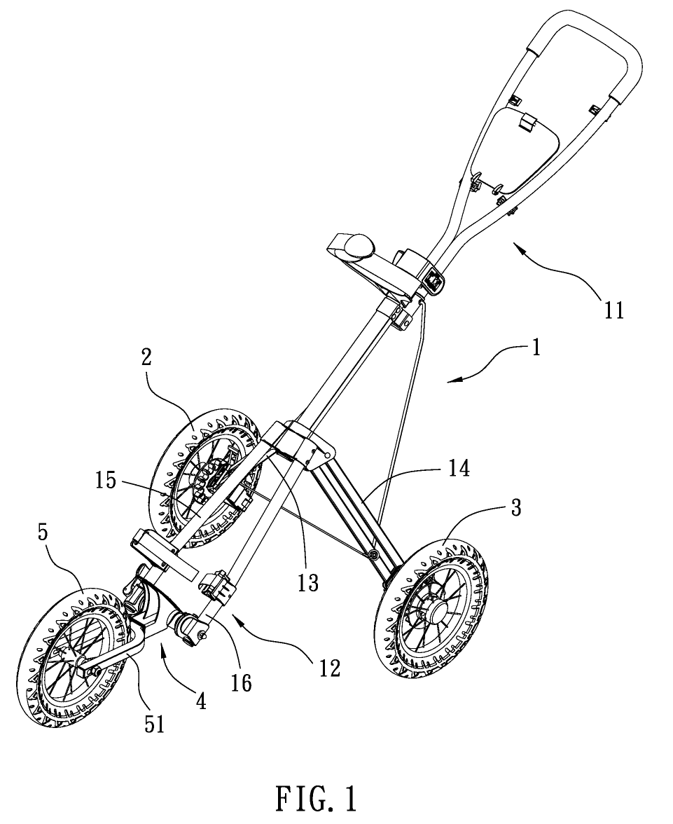

Referring to FIG. 1, the golf cart of the present invention mainly includes a frame body 1, a first wheel 2, a second wheel 3, a rotation shaft mechanism 4, and a front wheel 5.

The frame body 1 has a top end 11 and a bottom end 12. The frame body 1 has a first side frame 13 and a second side frame 14 respectively at lateral sides thereof. The first side frame 13 and the second side frame 14 are respectively and axially disposed the first wheel 2 and the second wheel 3 thereon. The first wheel 2 and the second wheel 3 are capable of in-situ rotation, and the bottom end 12 of the frame body 1 has a first bracket 15 and a second bracket 16.

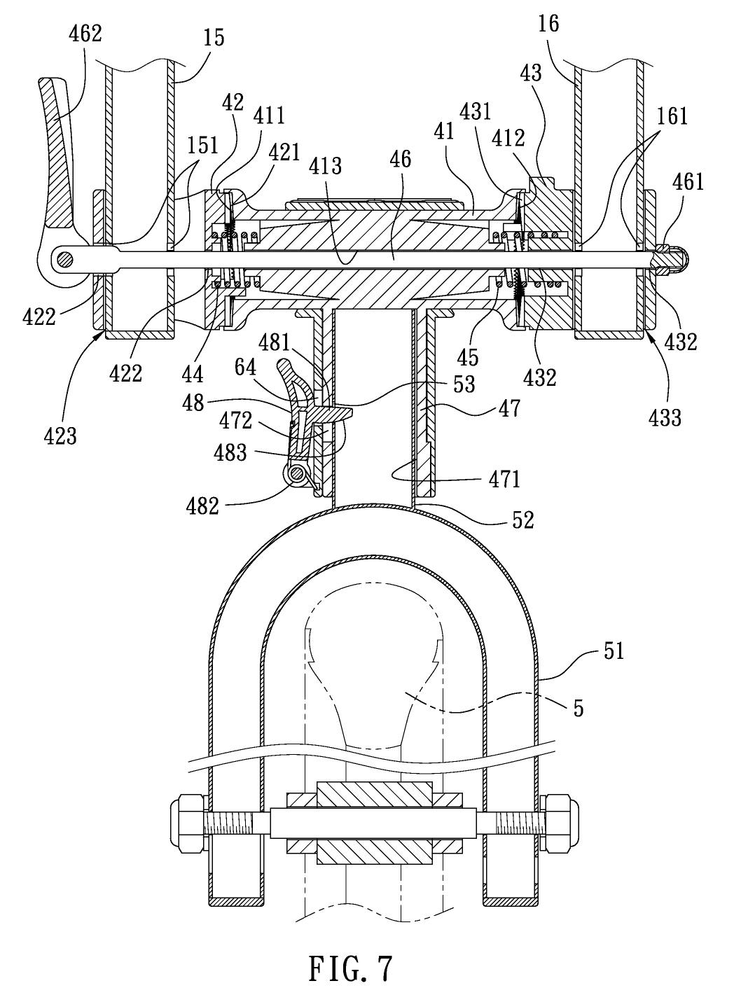

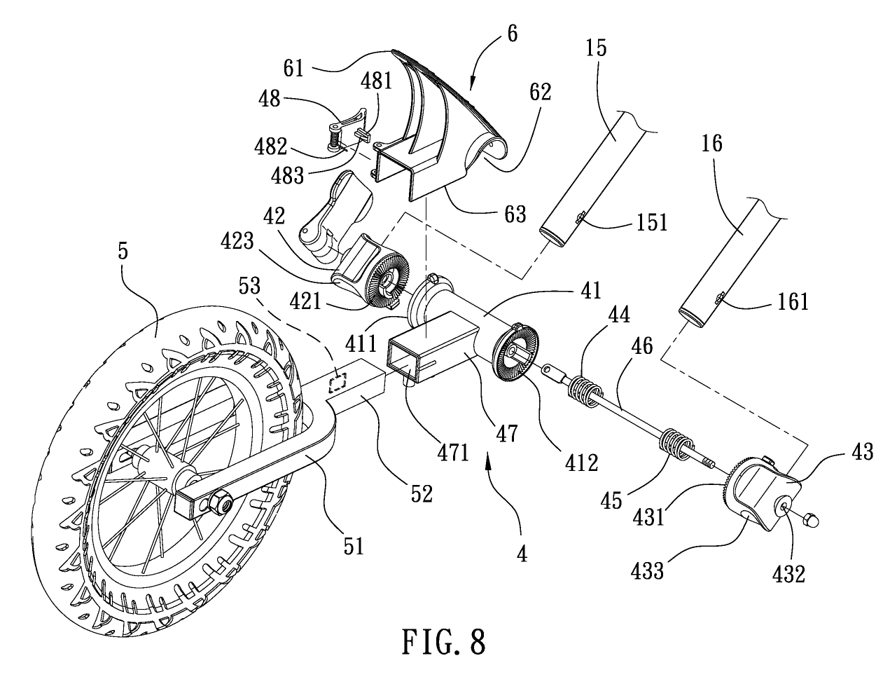

Referring to FIGS. 7 and 8, the rotation shaft mechanism 4 mainly includes a rotation shaft 41, the rotation shaft 41 has an abutting surface 411, 412 at each of the lateral sides thereof, and the rotation shaft 41 has a through hole 413 along an axial direction thereof; a first shaft fixing part 42, which is disposed at a lateral side of the rotation shaft 41, and has a braking surface 421 corresponding to the abutting surface 411 of the rotation shaft 41, the first shaft fixing part 42 has a horizontal perforation 422 and a vertical perforation 423; the first bracket 15 is received in the vertical perforation 423; a second shaft fixing part 43, which is disposed at the other side of the rotation shaft 41, and has a braking surface 431 corresponding to the abutting surface 412 of the rotation shaft 41, while the second shaft fixing part 43 has a horizontal perforation 432 and a vertical perforation 433, the second bracket 16 is received in the vertical perforation 433; a first resilient member 44 is mainly disposed between the first shaft fixing part 42 and the rotation shaft 41, a second resilient member 45 is mainly disposed between the second shaft fixing part 43 and the rotation shaft 41, in the figures, and the first resilient member 44 and the second resilient member 45 are mainly of coil compression spring, mainly for energy storage during compression, therefore, other resilient members are not limited, other forms of resilient members under this function are still in the scope of the present invention; an operation lever 46 mainly received in the through hole 413 of the rotation shaft 41, and the horizontal perforations 422, 432 of the first and the second shaft fixing parts 42, 43 at lateral sides of the rotation shaft 41, and the operation lever 46 has an escape prevention part 461 at an end thereof, and an eccentric wrench 462 at other end thereof, when the eccentric wrench 462 of the operation lever 46 compresses the first and the second shaft fixing parts 42, 43 to urge and fix the rotation shaft 41, the first and the second resilient members 44, 45 are compressed to store energy, when the eccentric wrench 462 is released, the first and the second resilient members 44, 45 release the energy and distract the rotation shaft mechanism 4, and the first and the second shaft fixing parts 42, 43 thus to release the rotation shaft 41, so that the rotation shaft 41 is in a release state, therefore, the hereinafter first wheel 5 can be expanded from or folded in the frame body 1; an insert connecting portion 47, which is disposed along an radial direction of the rotation shaft 41, the insert connecting portion 47 has an insert hole 471, the insert connecting portion 47 at its lateral side has a hole 472 communicated with the insert hole 471; a clip 48, which has a clip tongue 481, the clip tongue 481 has a slope 483, by means of operating the clip 48, the clip tongue 481 extends through the hole 472 and into the insert hole 471 or detaches from the insert hole 471, Furthermore, a spring 482 is disposed at an axial joint of the clip 38 and the insert connecting portion 47, to keep the clip 48 always in a clip state.

The front wheel 5 is rotatably and axially disposed on a wheel mount 51, the wheel mount 51 has an insert part 52, the insert part 52 at its at least a lateral side has an indentation 53, when the insert part 52 is inserted into the insert hole 471 of the insert connecting portion 47, the clip tongue 481 of the clip 48 is clasped into the indentation 53 of the insert part 52, so that the wheel mount 51 of the front wheel 5 is fixed. When the clip tongue 481 of the clip 48 is released, the wheel mount 51 of the front wheel 5 can be released and detached from the insert connecting portion 47.

The present invention has a bag mount mechanism 6 on the rotation shaft mechanism 4, the bag mount mechanism 6 co-rotate with the rotation shaft mechanism 4. The bag mount mechanism 6 of the present invention is integrally formed and mainly includes a bag mount 61, the bag mount 61 has a rotation shaft seat 62 and an insert connecting portion seat 63 at a bottom thereof. The rotation shaft seat 62 and the insert connecting portion seat 63 are fixed to the corresponded rotation shaft 41 and insert connecting portion 47. The fixing manner may select from bolt joint, adhesive bond, or other manners. Of course, the bag mount mechanism 6 may be integrally formed with the rotation shaft 41 from a single piece. Furthermore, the insert connecting portion seat 63 has a hole 64 at a lateral side thereof, while the clip 48 is disposed outside the insert connecting portion seat 63, and the clip tongue 481 may be inserted through the holes 64 and 472 and into the insert hole 471.

Moreover, the first bracket 15 has a perforation 151, while the second bracket 16 has a perforation 161 corresponding to the perforation 151. When the first bracket 15 is received in the vertical perforation 423 of the first shaft fixing part 42, and the second bracket 16 is received in the vertical perforation 433 of the second shaft fixing part 43, the operation lever 46 extends through the perforations 151 and 161, to unite the first bracket 15 and the second bracket 16 together with the rotation shaft mechanism 4. Therefore, the operation lever 46 not only controls the fixation or release of the rotation shaft 41, but also may be used to unite the first bracket 15 and the second bracket 16 together with the rotation shaft mechanism 4.

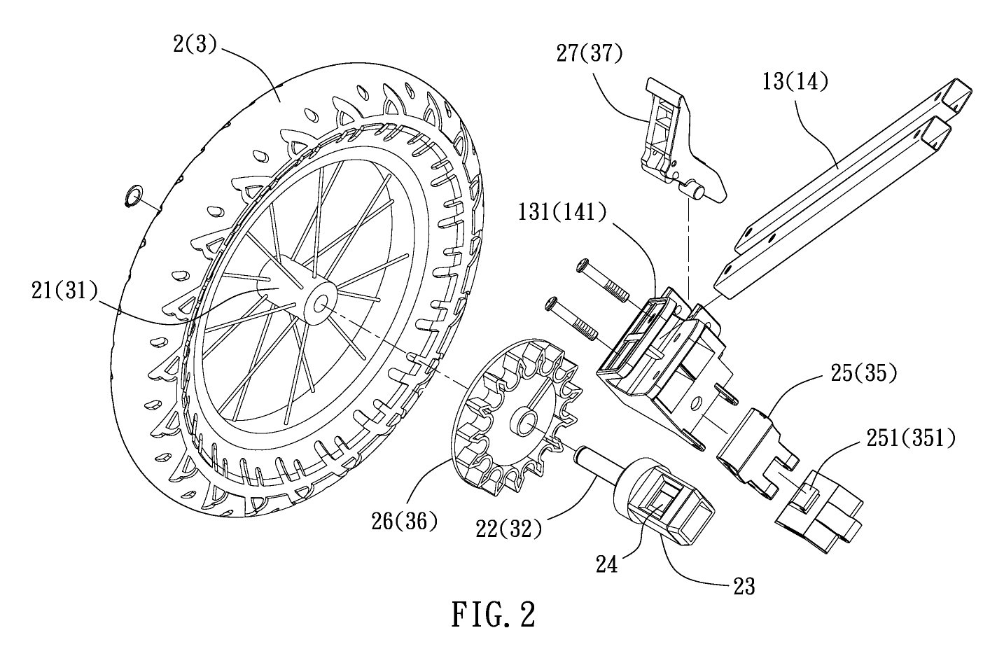

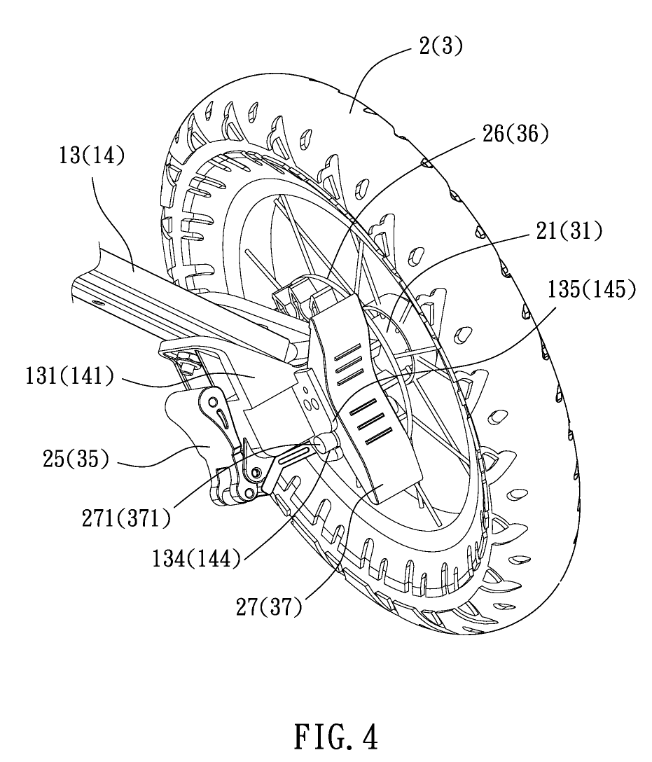

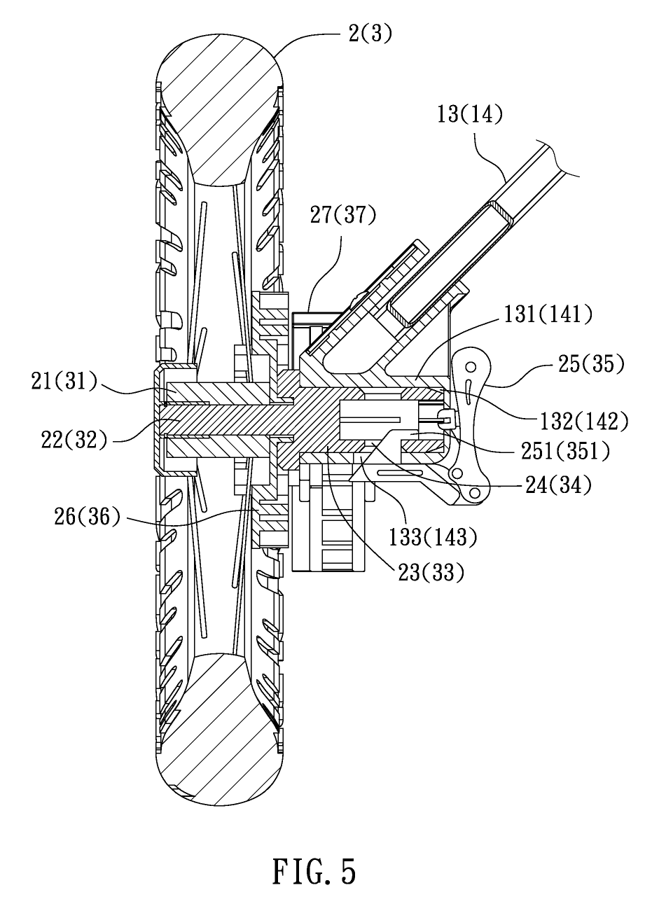

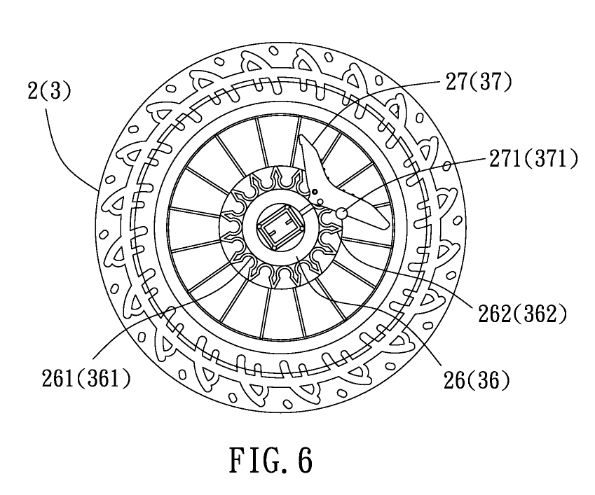

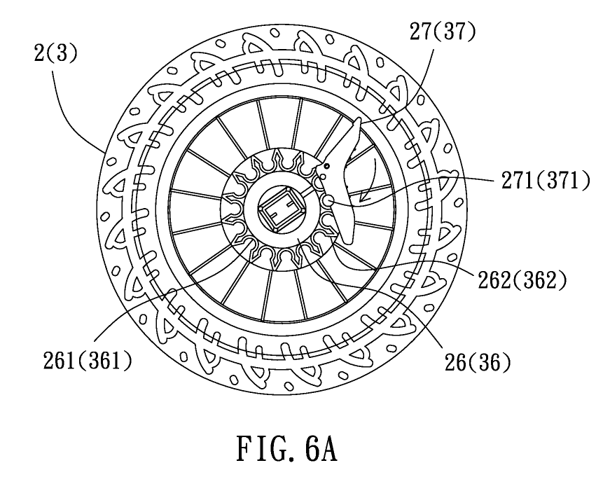

Referring to FIGS. 2, 4 through 6A, the wheel shafts 21, 31 of the first wheel 2 and the second wheel 3 are respectively and pivotally disposed a rotation shaft 22, 32 thereon. The rotation shafts 22, 32 respectively have a fixing portion 23, 33, the fixing portions 23, 33 respectively have an indentation 24, 34 along a radial direction thereof, the first and the second side frames 13, 14 respectively have an insert connecting portion 131, 141, the insert connecting portions 131, 141 respectively has an insert hole 132, 142 corresponding to the fixing portion 23, 33, the insert connecting portion 131, 141 at its lateral side has a hole 133, 143 communicated with the insert hole 132, 142.

In the forgoing embodiments, the present invention further includes a clip 25, 35 disposed on the insert connecting portion 131, 141. The clips 25, 35 respectively has a clip tongue 251, 351, by means of operating the clips 25, 35, the clip tongues 251, 351 can extend through the holes 133, 143 and into the insert holes 132, 142 or detach from the insert holes 132, 142, therefore, when the fixing portions 23, 33 of the first wheel 2 and the second wheel 3 are inserted into the insert holes 132, 142 of the insert connecting portions 131, 141, the clip tongues 251, 351 of the clips 25, 35 are clasped to fix the rotation shafts 22, 32 of the first and the second wheels 2, 3, and conversely to release the rotation shafts 22, 32 to benefit for taking out the first wheel 2 and the second wheel 3.

The first wheel 2 and the second wheel 3 each has a stop wheel 26, 36 at a lateral side thereof, while the first side frame 13 and the second side frame 14 each is pivotally disposed a braking lock 27, 37 thereon. The braking lock 27, 37 at a first position could clasp the stop wheel 26, 36, and at a second position could release the stop wheel 26, 36. In the embodiment, the stop wheel 26, 36 has a plurality of clasping grooves 261, 361, and the insert connecting portion 131, 141 of the first side frame 13 and the second side frame 14 has a plurality of clasping grooves 134, 144, while the braking lock 27, 37 has a plurality of corresponded clasping bolts 271, 371. Furthermore, the openings of the clasping grooves 261, 361 has slantwise guiding portion 262, 362, while the clasping grooves 134, 144 also have slantwise guiding portions 135, 145, for guiding the clasping bolts 271, 371 to enter into the corresponding clasping grooves 261, 361 and clasping grooves 134, 144. Moreover, terminal ends of the first side frame 13 and the second side frame 14 are movably and pivotally disposed the insert connecting portions 131, 141 respectively, uniting the first wheel 2 and the second wheel 3 via the insert connecting portions 131, 141, and the braking locks 27, 37 are disposed on the insert connecting portions 131, 141.

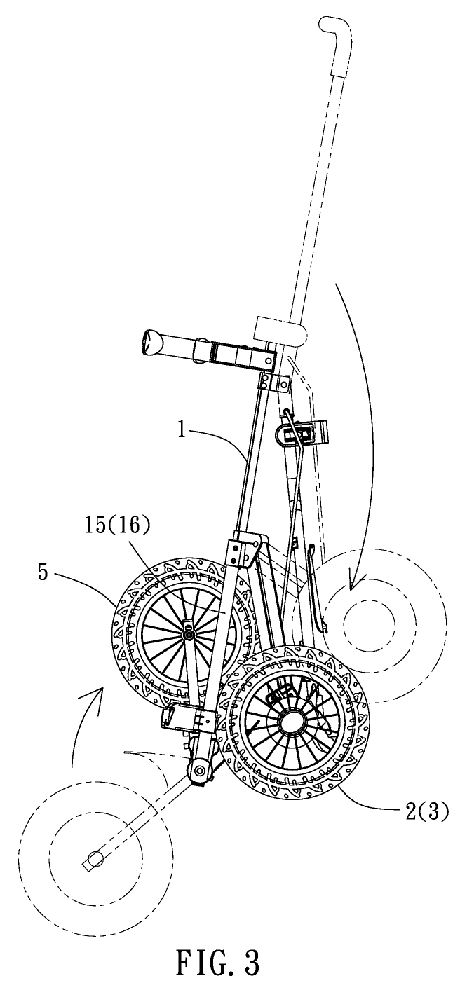

Referring to FIG. 3, the present invention mainly utilizes the rotation shaft mechanism to make the front wheel rotate around the axis of the rotation shaft and could be positioned, and utilizes the operation of the clip to facilitate the fixation and the detachment of the wheel frame for the front wheel, so that users can select whether to use the front wheel, and after the front wheel is assembled, the front wheel can further be folded in or expanded from the frame body for facilitate its usage, storage, or transportation.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A golf cart comprising:
a frame body, the frame body having a top end and a bottom end, lateral sides of the frame body respectively having a first side frame and a second side frame, the first side frame and the second side frame respectively and axially being disposed a first wheel and a second wheel thereon, the first wheel and the second wheel being capable of in-situ rotation, and the bottom of the frame body having a first bracket and a second bracket;
a rotation shaft mechanism, including a rotation shaft, lateral sides of the rotation shaft respectively having an abutting surface, and the rotation shaft at an axial direction thereof having a through hole; a first shaft fixing part, being disposed at a lateral side of the rotation shaft, and having a braking surface corresponding to the abutting surface of the rotation shaft, the first shaft fixing part having a horizontal perforation and a vertical perforation, the first bracket being received in the vertical perforation; a second shaft fixing part, being disposed at the other side of the rotation shaft, and having a braking surface corresponding to the abutting surface of the rotation shaft, while the second shaft fixing part having a horizontal perforation and a vertical perforation, the second bracket being received in the vertical perforation; a first resilient member being disposed between the first shaft fixing part and the rotation shaft; a second resilient member being disposed between the second shaft fixing part and the rotation shaft; an operation lever being received in the through hole of the rotation shaft and the horizontal perforations of the first and the second shaft fixing parts at lateral sides of the rotation shaft, and the operation lever having an escape prevention part at an end thereof, and an eccentric wrench at other end thereof, when the eccentric wrench of the operation lever compressing the first and the second shaft fixing parts, to urge and fix the rotation shaft, the first and the second resilient members, being compressed to store energy, when the eccentric wrench being released, the first and the second resilient members releasing the energy and distracting the rotation shaft mechanism, and the first and the second shaft fixing parts to release the rotation shaft; an insert connecting portion, being disposed along an radial direction of the rotation shaft, the insert connecting portion having an insert hole, the insert connecting portion at a lateral side thereof having a hole communicated with the insert hole;
a clip, which has a clip tongue, by means of operating the clip, the clip tongue extending through the hole and into the insert hole or detaching from the insert hole; and
a front wheel, the front wheel being rotatably and axially disposed on a wheel mount, the wheel mount having an insert part, the insert part at its at least a lateral side having an indentation, when the insert part being inserted into the insert hole of the insert connecting portion, the clip tongue of the clip being clasped into the indentation of the insert part, so that the wheel mount for the front wheel being fixed, when the clip tongue of the clip being released, the wheel mount for the front wheel being released and detached from the insert connecting portion.

2. The golf cart as claimed in claim 1, wherein the wheel shaft of the first wheel is pivotally disposed a rotation shaft thereon, the rotation shaft has a fixing portion, and the fixing portion has an indentation along a radial direction thereof, the first side frame has an insert connecting portion, the insert connecting portion has an insert hole corresponding to the fixing portion, and the insert connecting portion at a lateral side thereof has a hole communicated with the insert hole; when the fixing portion is inserted into the insert hole of the insert connecting portion, the clip tongue of the clip is clasped to fix the rotation shaft, and conversely to release the rotation shaft.

3. The golf cart as claimed in claim 1, wherein the wheel shaft of the second wheel is pivotally disposed a rotation shaft thereon, the rotation shaft has a fixing portion, and the fixing portion has an indentation along a radial direction thereof, the second side frame hasg an insert connecting portion, the insert connecting portion has an insert hole corresponding to the fixing portion, and the insert connecting portion at a lateral side thereof having a hole communicated with the insert hole; when the fixing portion is inserted into the insert hole of the insert connecting portion, the clip tongue of the clip is clasped to fix the rotation shaft, and conversely to release the rotation shaft.

4. The golf cart as claimed in claim 1, wherein the first wheel has a stop wheel at a lateral side thereof, while the first side frame is pivotally disposed a braking lock thereon, the braking lock at a first position clasps the stop wheel, and at a second position releases the stop wheel.

5. The golf cart as claimed in claim 4, wherein the stop wheel has a plurality of clasping grooves, while the braking lock has a plurality of corresponded clasping bolts.

6. The golf cart as claimed in claim 4, wherein the first side frame is movably and pivotally disposed an insert connecting portion for uniting the first wheel, and the braking lock is disposed on the insert connecting portion.

7. The golf cart as claimed in claim 1, wherein the second wheel has a stop wheel at a lateral side thereof, while the second side frame is pivotally disposed a braking lock thereon, the braking lock at a first position clasps the stop wheel, and at a second position releases the stop wheel.

8. The golf cart as claimed in claim 7, wherein the stop wheel has a plurality of clasping grooves, while the braking lock having a plurality of corresponded clasping bolts.

9. The golf cart as claimed in claim 7, wherein the second side frame is movably and pivotally disposed an insert connecting portion for uniting the second wheel, and the braking lock is disposed on the insert connecting portion.

10. The golf cart as claimed in claim 1, further comprising a bag mount mechanism on the rotation shaft mechanism, the bag mount mechanism co-rotating with the rotation shaft mechanism.

11. The golf cart as claimed in claim 1, further comprising a bag mount mechanism, the bag mount mechanism integrally forming a bag mount, the bag mount having a rotation shaft seat and an insert connecting portion seat at a bottom end thereof, the rotation shaft seat and the insert connecting portion seat being fixed to the corresponded rotation shaft and insert connecting portion.

12. The golf cart as claimed in claim 1, wherein the first bracket has a perforation, while the second bracket has a perforation corresponding to the perforation, when the first bracket being received in the vertical perforation of the first shaft fixing part, and the second bracket being received in the vertical perforation of the second shaft fixing part, the operation lever extending through the two perforations.
